(19) United States
(12) Patent Application Publication
(10) Pub. No.: US 2018/0324300 A1
(43) Pub. Date: Nov. 8, 2018

(54) EMERGENCY CALL DETECTION SYSTEM

(71) Applicant: QUALCOMM Incorporated, San Diego, CA (US)

(72) Inventors: Ankit BANAUDHA, Hyderabad (IN); Amandeep Singh BEDI, Hyderabad (IN); Ashokkumar NARAYANASWAMY, Hyderabad (IN); Ashutosh GUPTA, Hyderabad (IN)

(21) Appl. No.: 15/589,892

(22) Filed: May 8, 2017

(51) Int. Cl. H04M 3/51; H04L 29/06; H04W 76/00; H04W 4/22; G08B 25/08; G08B 25/01

(52) U.S. Cl. CPC H04M 3/5116; H04L 65/602; H04W 76/007; H04W 4/22; H04W 40/02; G08B 25/016; H04L 65/4007; H04M 2242/04; H04M 2207/18; G08B 25/08

(57) ABSTRACT

In an aspect, a method, a computer-readable medium, and an apparatus for emergency call detection at a user equipment (UE) are provided. The apparatus detects an incoming emergency call at the UE from an emergency service authority, and determines a time duration between an outgoing emergency call from the UE and the detected incoming emergency call from the emergency service authority. Further, the apparatus answers automatically the incoming emergency call from the emergency service authority based on the determined time duration. Moreover, the apparatus obtains a live stream of at least one of sound captured through a microphone of the UE or images captured through one or more cameras of the UE upon answering the incoming emergency call. Additionally, the apparatus sends the obtained live stream of the at least one of the captured sound or the captured images to the emergency service authority during the incoming emergency call.

### BACKGROUND

### Field

The present disclosure relates generally to a call detection systems, and more particularly, to an emergency call detection system.

### Background

Ideally, when an emergency call is dialed, there should not be any delay from the time an emergency call is initiated to the time the call is answered by an emergency operator. However, due to the large volume of emergency calls dialed in a given day, there may be a few seconds of delay before the emergency operator answers the phone call. The call connection time (e.g., 2 s to 10 sec depending on the response time in a particular location) before answering a call by the emergency operator may also be considered as part of the delay in answering the call. In case of a user placing an emergency call using an user equipment (UE) with no embedded subscriber identification module (SIM), the delay in answering an emergency call by the emergency operator may be more due to the time required for the UE to scan an available frequency before placing the call than due to the delay in answering the emergency call.

In an emergency situation, (for example, a home invasion burglary, a fire, or the like) reducing response time may save someone's life, since circumstances may change in the matter of seconds. In such a case, the emergency operator calls back immediately to check on the caller who placed the emergency call. However, if the caller is still under danger, he/she may be forced to make an excuse about the emergency call being placed unintentionally or by mistake. In some cases, in an emergency situation, during the time from when the emergency call is initiated and when the emergency call is connected, the circumstances of the situation may change and the caller may be unable to describe the situation or have to disconnect the call due to injury, unconsciousness or the presence of a perpetrator in the vicinity of the caller. In such cases, when the call from the emergency operator remains unanswered, the emergency operator alerts the police dispatch after tracking the phone number and the last known location (for example, by using a global positioning system (GPS) in the caller's UE). Thus, the response time of the police/fire department may be elongated, which may be detrimental in case of a life and death situation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Ideally, when an emergency call is dialed, there should be no delay from the time an emergency call is initiated to the time the call is answered by an emergency operator. However, due to the large volume of emergency calls in a given day, there may be a few seconds of delay before the emergency operator answers the phone call. In an emergency situation, reducing response time may save someone's life, since circumstances may change in the matter of seconds. In such a case, the emergency operator calls back immediately to check on the caller who placed the emergency call. In many cases, when the call from the emergency operator remains unanswered, the emergency operator alerts the police dispatch after tracking the phone number and the last known location (for example, by using a GPS in the caller's UE). Thus, the response time of the police/fire department may be elongated, which may be detrimental in case of a life and death situation. Therefore, there is a need for an emergency call detection system which may collect and provide additional information regarding the emergency situation by using different peripheral devices embedded into the caller's UE and one or more peer devices in communication with the UE or in the vicinity of the UE.

In an aspect of the disclosure, a method, a computer-readable medium, and an apparatus for emergency call detection at a UE are provided. The apparatus detects an incoming emergency call at the UE from an emergency service authority. The apparatus also determines a time duration between an outgoing emergency call from the UE and the detected incoming emergency call at the UE from the emergency service authority. Further, the apparatus answers automatically the incoming emergency call from the emergency service authority based on the determined time duration. Moreover, the apparatus obtains a live stream of at least one of sound captured through a microphone of the UE or images captured through one or more cameras of the UE upon answering the incoming emergency call. Additionally, the apparatus sends the obtained live stream of the at least one of the captured sound or the captured images to the emergency service authority during the incoming emergency call.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a configuration of an emergency call detection system implemented in a real life emergency situation scenario.

FIG. 2 is a flowchart of a method of detecting an outgoing emergency call originated from a UE.

FIG. 3A is a flowchart of a method of automatically answering an incoming emergency call at a UE.

FIG. 3B is a flowchart of a method of recording and sending the sound or images captured by the UE to the emergency service authority.

FIG. 3C is a flowchart of a method of recording sound or images at the peer device and sending the recorded sound or images to the emergency service authority.

FIG. 3D is a flowchart of a method of obtaining a live stream of sound or images through the peer device and sending the live stream to the emergency service authority.

FIG. 3E is a flowchart of a method of determining the position of the UE and sending the determined position to the emergency service authority.

FIG. 4 is a conceptual data flow diagram illustrating the data flow between different means/components in an exemplary apparatus.

FIG. 5 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of an emergency call detection system will now be presented with reference to various apparatus and methods. The apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Ideally, when an emergency call is dialed, there should be no delay from the time an emergency call is initiated to the time the call is answered by an emergency operator. However, due to the large volume of emergency calls in a given day, there may be a few seconds of delay before the emergency operator answers the phone call. The call connection time (e.g., 2 s to 10 sec depending on the response time in a particular location) before answering a call by the emergency operator may also be considered as part of the delay in answering the call. In case of a user placing an emergency call using a UE with no embedded SIM, the delay in answering an emergency call by the emergency operator may be due more to the time required for the UE to scan an available frequency before placing the call than due to the delay in answering the emergency call.

In an emergency situation, (for example, a home invasion burglary, a fire, or the like) reducing response time may save someone's life, since circumstances may change in the matter of seconds. In such a case, the emergency operator calls back immediately to check on the caller who placed the emergency call. However, if the caller is still under danger, he/she may be forced to make an excuse about the emergency call being placed unintentionally or by mistake. In some cases, during an emergency situation, between the times the emergency call is placed and the emergency call is connected, the circumstances of the situation may change and the caller may be unable to describe the situation or have to disconnect the call due to injury, unconsciousness or the presence of a perpetrator in the vicinity of the caller. In such cases, when the call from the emergency operator remains unanswered, the emergency operator alerts the police dispatch after tracking the phone number and the last known location (for example, by using a GPS in the caller's UE). Thus, the response time of the police/fire department may be elongated, which may be detrimental in case of a life and death situation. Therefore, there is a need for an emergency call detection system which may collect and provide additional information regarding the emergency situation by using different peripheral devices embedded into the caller's UE and one or more peer devices in communication with UE.

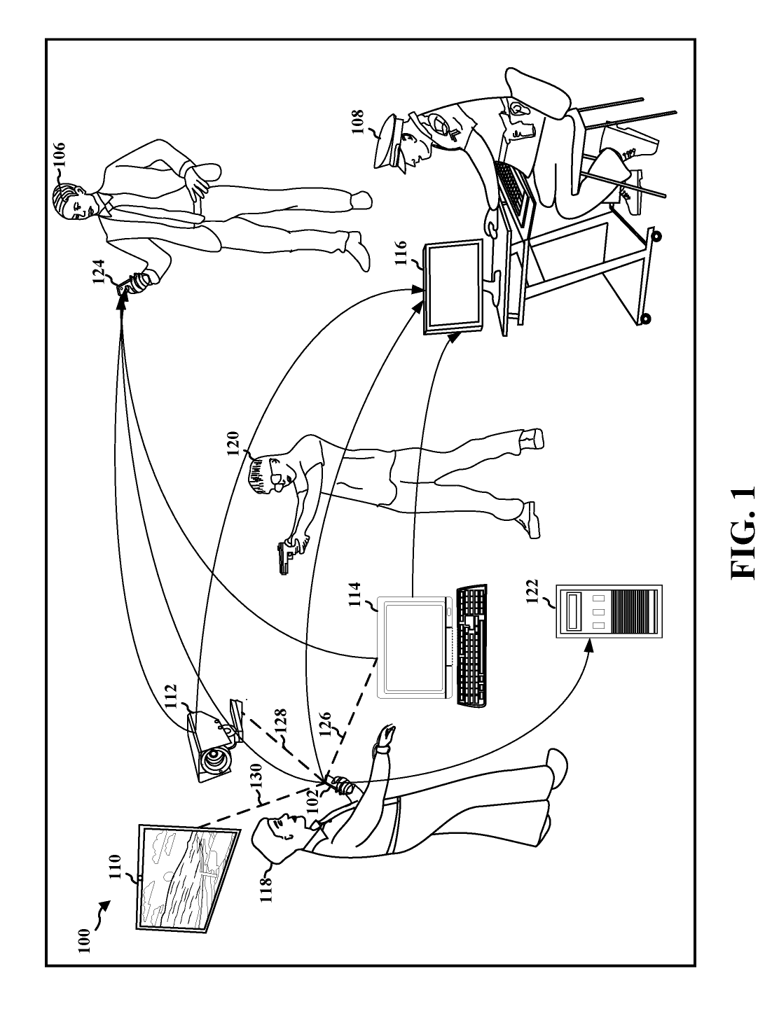

FIG. 1 is a diagram illustrating a configuration of an emergency call detection system 100 implemented in a real life emergency situation scenario. The emergency call detection system 100 may include a UE 102 in communication with one or more peer devices, for example, a laptop computer 114, a smart webcam 112, and a smart television 110, in a vicinity of the UE 102. The UE 102 may be wirelessly connected (via WIFI™ or BLUETOOTH™) with the one or more peer devices (e.g., 110, 112, 114). For example, the UE 102 may be connected to the smart television 110 via wireless connection 130, the smart webcam 112 may be connected to the UE 102 via a wireless connection 128, and the laptop computer 114 may be connected to the UE 102 via a wireless connection 126. The emergency call detection system 100 may also include a server 122 in communication with the UE 102 and the one or more peer devices (e.g., 110, 112, 114) via a wireless communication network (e.g., a LTE wireless communication network). The number of one or more peer devices may be different in other embodiments depending on the application.

One or more emergency phone numbers (e.g., phone numbers of the police station, the fire department, the ambulance service, or a common phone number for all the emergency phone numbers, for example, 911 in USA, or the phone number of a non-government security service authority such as a private security service, for example, ADT, KBR, CORPS etc., that provides security service to the home of the home owner 118) may be saved in the SIM memory of the UE 102 or in the Multi Media Extension (MME) memory of the UE 102 in case the UE 102 does not have a SIM. In one configuration, the UE 102 may be one of a smart phone, a tablet, a laptop, an Internet of Things (IoT) device, Internet of Everything (IoE) device, enhanced Machine Type Communications (eMTC) device, Closed-circuit television (CCTV) camera, an electronic microphone, or the like.

In an emergency situation, for example, home invasion burglary, as soon as the caller or the home owner 118 places an emergency call using the UE 102, the UE 102 may detect the emergency call by recognizing the emergency phone number saved in the SIM or the MME memory of the UE 102. In one configuration, a modem embedded inside the UE 102 or an application running inside the UE 102 may detect the emergency call by recognizing the emergency phone number saved in the SIM or the MME memory of the UE 102. As soon as the emergency number is detected, the UE 102 may turn on one or more sound recorders embedded in the UE 102 to record ambient sounds and one or more human voices. The human voices may be detected by a voice detector embedded in the sound recorders inside the UE 102. For example, in case of a home invasion burglary, the caller or the home owner 118 may place an emergency call using the UE 102 by dialing an emergency phone number saved in the SIM or the MME memory of the UE 102. As soon as the emergency phone call is detected, the one or more sound recorders embedded in the UE 102 are turned on to record ambient sounds (e.g., sound of gunshot, human voices, a conversation between the caller/home owner 118 and the perpetrator 120).

The UE 102 may also turn on one or more cameras embedded in the UE 102 as soon as the UE detects the emergency phone number being dialed from the UE 102. As soon as the cameras embedded in the UE 102 are turned on, the video cameras start recording the ambient environment of the UE 102. For example, in case of a home invasion burglary, the cameras embedded in the UE 102 may record the video of the burglary in progress. In one configuration, the UE 102 may store the recorded ambient sounds, the human voices, and the video to the server 122. For example, the UE 102 may store the sound of a gunshot, the conversation between the caller or the home owner 118 and the perpetrator 120 and the still/video of the burglary in progress at the location of the caller/the house of the home owner 118 to the server 122.

In another configuration, the UE 102 may convert the recorded human voices to a text format and transfer the text and the recorded video to a device 116 in possession of a government authority 108 (e.g., police) and/or to a device 124 in possession of a non-government authority 106 (e.g., a friend or a family member). In one configuration, the non-government authority 106 may be a non-government security service authority 106 (e.g., a private security service, for example, ADT, KBR, CORPS etc.). In another configuration, the government authority 108 may be a local emergency call operation center of the local police or a local police station operator. For example, the UE 102 may convert the recorded conversation between the caller/home owner 118 and the perpetrator 120 to a text format and transfer the text and the recorded video of the burglary in progress at the house of the home owner 118, to a computer 116 in possession of a local police station operator 108 and/or to a device 124 (e.g., a mobile device) in possession of a friend or a family member of the home owner 118 or a private security service 106 used by the home owner 118. In some configurations, the UE 102 may send the text of the recorded conversation to the device 116 in possession of the government authority 108, and/or to a device 124 in possession of the non-government authority or the non-government security service authority 106 (e.g., a friend or a family member or a private security service) separately from the recorded video.

In one configuration, the UE 102 may turn on a GPS embedded in the UE 102. The UE 102 may determine a position of the UE 102 based on the GPS. The UE 102 may also determine a position of the UE 102 with respect to neighboring base stations, or a position of the UE 102 with respect to neighboring access points. The UE 102 may transfer the current position of the UE 102 to the device 116 in possession of a government authority 108 (e.g. police station operator) and/or to the device 124 in possession of a non-government authority/the non-government security service authority 106 (e.g., a friend or a family member or a private security service).

In some cases, during an emergency situation (e.g., a home invasion burglary), between the time the emergency call is placed and the emergency call is answered, the circumstances may change and the caller or the home owner 118 may be unable to describe the situation or have to disconnect the call due to injury, unconsciousness or the presence of a perpetrator 120 in the vicinity of the caller. In such cases, the government authority 108 (e.g. a police operator) or the non-government security service authority 106 (e.g., a private security service) calls back to check on the caller or the home owner 118 who placed the emergency call. In such cases, as soon as the incoming emergency call from the government authority 108 (e.g. a police station operator) or the non-government security service authority 106 (e.g., a private security service) is connected to the UE 102, the UE 102 may detect that the incoming call is an emergency incoming call by recognizing the emergency phone number saved in the SIM or the MME memory of the UE 102.

Upon detection of the emergency number, the UE 102 may determine a time duration between the outgoing emergency call from the UE 102 and the detected incoming emergency call from the government authority 108 (e.g. a police station operator) or the non-government security service authority 106 (e.g., a private security service). If the time duration between the outgoing emergency call attempted from the UE 102 and the detected incoming emergency call from the government authority 108 (e.g. a police operator) or the non-government security service authority 106 (e.g., a private security service) is determined to be less than a certain amount of time (e.g., 5 minutes), the UE 102 may enable an auto answering feature embedded in the operating system of the UE 102 to automatically answer the incoming emergency call from the government authority 108 (e.g. a police station operator) or the non-government security service authority 106 (e.g., a private security service). As soon as the incoming call from the government authority 108 (e.g. a police station operator) or the non-government security service authority 106 (e.g., a private security service) is answered, the existing security protocols embedded in the operating systems of the UE 102 may be overridden.

Next, the UE 102 may turn on one or more microphones and/or sound recorders embedded in the UE 102 to capture and/or record ambient sounds and/or one or more human voices. The UE 102 may also turn on one or more cameras embedded in the UE 102 to capture and/or record the ambient environment of the UE 102. In one configuration, the UE 102 may obtain a live stream of the ambient sounds (e.g., sound of a gunshot) and the human voices (e.g., the conversation between the caller/the home owner 118 and the perpetrator 120) captured through the microphone of the UE 102, and the images captured through the cameras of the UE 102 (e.g., still/video of the burglary in progress at the location of the caller or the home owner 118 captured through the cameras of the UE 102). The UE 102 may transfer the obtained live stream of the captured ambient sounds, human voices, and the images to the device 116 (e.g., a computer) in possession of a government authority 108 (e.g. a police station operator) and/or to the device 124 in possession of a non-government authority/the non-government security service authority 106 (e.g., a friend or a family member or a private security service). In another configuration, the UE 102 may record the ambient sounds (e.g., sound of a gunshot) and the human voices (e.g., the conversation between the caller/the home owner 118 and the perpetrator 120) captured through the microphone of the UE 102, and the images captured through the cameras of the UE 102 (e.g., still/video of the burglary in progress at location of the caller/the house of the home owner 118 captured through the cameras of the UE 102). The UE 102 may transfer the recorded ambient sounds, human voices, and/or the images to the device 116 (e.g., a computer) in possession of a government authority 108 (e.g. a police station operator) and/or to the device 124 in possession of a non-government authority/the non-government security service authority 106 (e.g., a friend or a family member or a private security service).

In one configuration, as soon as the UE 102 detects an emergency number (e.g., in case of an incoming or an outgoing emergency call), the UE 102 may send a request to one or more peer devices (e.g., 110, 112, 114), via the wireless connections 126, 128, and 130, to allow the UE 102 to override the existing security protocols embedded in the operating systems of the one or more peer devices (e.g., 110, 112, 114). Once the one or more peer devices (e.g., 110, 112, 114) accept the UE's 102 request, the UE 102 may override the security protocols embedded in the operating systems of the one or more peer devices (e.g., 110, 112, 114) and may take full control of the one or more peer devices (e.g., 110, 112, 114).

Next, the UE 102 may turn on one or more sound recorders embedded in the one or more peer devices (e.g., 110, 112, 114) to capture/record ambient sounds (e.g., sound of a gunshot) and human voices (e.g., conversation between the caller/the home owner 118 and the perpetrator 120). The human voices may be detected by a voice detector embedded in the sound recorders in the one or more peer devices (e.g., 110, 112, 114). The UE 102 may also turn on one or more cameras embedded in the one or more peer devices (e.g., 110, 112, 114) to capture/record the ambient environment of the one or more peer devices (e.g., 110, 112, 114). For example, in case of a home invasion burglary, the cameras in the one or more peer devices (e.g., 110, 112, 114) may capture/record the video of the burglary in action from different angles than the camera in the UE 102, which may help in identifying the perpetrator 120. In one configuration, the one or more peer devices (e.g., 110, 112, 114) may be located either at the same room as the UE 102 or in one or more neighboring rooms inside the house of the home owner 118. In some cases, the one or more peer devices (e.g., 110, 112, 114) may be located outside the house of the home owner 118 which may record the activity of one or more accomplices of the perpetrator 120. In one configuration, the one or more peer devices (e.g., 110, 112, 114) may be one or more devices coupled with the UE 102 or previously coupled with the UE 102.

In one configuration, the UE 102 may store the recorded ambient sounds (e.g., sound of a gunshot), human voices (e.g., the conversation between the caller/the home owner 118 and the perpetrator 120), and the images (e.g., still or video of the burglary in action at the location of the caller/the house of the home owner 118), recorded by the sound recorders and the cameras in the one or more peer devices (e.g., 110, 112, 114), to the server 122 in communication with the UE 102. In one configuration, the ambient sounds, human voices, and the videos recorded at the one or more peer devices (e.g., 110, 112, 114) may be transferred to the server 122 directly from the one or more peer devices (e.g., 110, 112, 114) via a wireless communication network (e.g., a LTE wireless communication network). In another configuration, the ambient sounds, human voices, and the videos recorded at the one or more peer devices (e.g., 110, 112, 114) may first be transferred to the UE 102 using WIFI™ or BLUETOOTH™ and then the UE 102 may transfer the recorded ambient sounds, human voices, and the videos to the server 122.

In one configuration, the one or more peer devices (e.g., 110, 112, 114) may transfer the ambient sounds (e.g., sound of a gunshot), human voices (e.g., the conversation between the caller/the home owner 118 and the perpetrator 120), and the images (e.g., still/video of the burglary in action at the location of the caller/the house of the home owner 118) captured/recorded by the sound recorders and the cameras in the one or more peer devices (e.g., 110, 112, 114) to the UE 102, via WIFI™ or BLUETOOTH™. The UE 102 may transfer the received recordings of the ambient sounds (e.g., sound of a gunshot), human voices (e.g., the conversation between the caller/the home owner 118 and the perpetrator 120), and the images (e.g., still/video of the burglary in action at the location of the caller/the house of the home owner 118), recorded by the one or more peer devices (e.g., 110, 112, 114), as an attachment, to a device 116 in possession of a government authority 108 (e.g. a police station operator) and/or to a device 124 in possession with a non-government authority/the non-government security service authority 106 (e.g., a friend or a family member or a private security service). In another configuration, the UE 102 may transfer a live feed of the ambient sounds (e.g., gunshots), the human voices (e.g., the conversation between the caller/the home owner 118 and the perpetrator 120), and the images (e.g., still/video of the burglary in action at the location of the caller/the home owner's 118 house), captured by the one or more peer devices (e.g., 110, 112, 114), to a device 116 in possession of a government authority 108 (e.g. a police operator) and/or to a device 124 in possession with a non-government authority/the non-government security service authority 106 (e.g., a friend or a family member or a private security service).

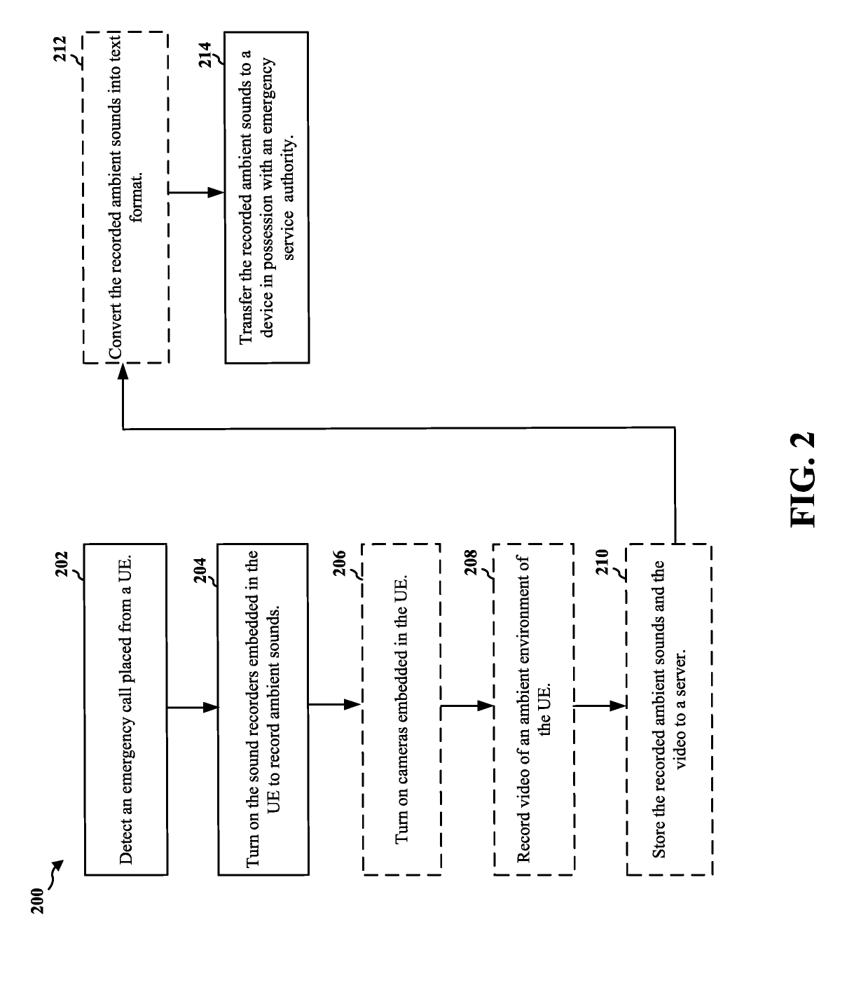

FIG. 2 is a flowchart 200 of a method of detecting an emergency call originated from a UE, and subsequently collecting and providing additional information regarding the emergency situation by using one or more different peripheral devices embedded into the caller's UE, according to an aspect. The method may be performed by a UE (e.g., the UE 102).

At 202, the UE detects an emergency call placed from the UE. For example, during a home invasion burglary, as soon as the caller or the home owner 118 places an emergency call using the UE 102, the UE 102 may detect the emergency call by recognizing the emergency phone number saved in the SIM or the MME memory of the UE 102. In an aspect, the UE 102 may compare the called number with the stored one or more emergency numbers and detect a match.

At 204, the UE may turn on one or more sound recorders embedded in the UE to record ambient sounds. For example, the UE 102 may turn on the one or more sound recorders embedded in the UE 102 to record ambient sounds (e.g., sound of gunshot) and/or one or more human voices, e.g., conversation between the caller/the home owner 118 and the perpetrator 120. The one or more human voices may be detected by a voice detector embedded in each of the sound recorders inside the UE 102.

Optionally, at 206, the UE (UE 102) may also turn on one or more cameras embedded in the UE (UE 102).

Optionally, at 208, the cameras embedded in the UE record the video of the ambient environment of the UE. For example, in case of a home invasion burglary, the cameras embedded in the UE 102 may record the video of the burglary in progress.

Optionally, at 210, the UE may store the recorded ambient sounds, and the video to a server in communication with the UE. For example, the UE 102 may store the sound of a gunshot, the conversation between the caller/the home owner 118 and the perpetrator 120 and the video of the burglary in progress at the location of the caller or the house of the home owner 118, to the server 122 in communication with the UE 102. In one configuration, the server 122 may be maintained by a vendor or a service provider. In another configuration, the server 122 may be a cloud server.

Optionally, at 212, the UE (UE 102) may convert the recorded ambient sounds (e.g., human voices) into text format. In one configuration, the UE 102 may convert the recorded ambient sounds (e.g., human voices) into text format using a speech recognition software embedded in the UE 102.

At 214, the UE may transfer the recorded ambient sounds to the device in possession of an emergency service authority. In one configuration, the authority may be a government authority and/or a non-government authority. In one configuration, the non-government authority 106 may be a non-government security service authority 106 (e.g., a private security service, for example, ADT, KBR, CORPS etc.). For example, the UE 102 may transfer the recorded sound of gunshot and the conversation between the caller/the home owner 118 and the perpetrator 120 to the device 116 in possession of a police operator 108 and/or to the device 124 in possession of a friend or a family member of the home owner 118 or a private security service 106 used by the home owner 118.

Optionally, the UE may transfer the text and the recorded video to the device in possession of a government authority and/or to the devices in possession of a non-government authority/a non-government security service authority. For example, the UE 102 may convert the recorded conversation between the caller/the home owner 118 and the perpetrator 120 into text format and transfer the text and the recorded video of the burglary in action at the location of the caller or the house of the home owner 118, to the device 116 in possession of a police operator 108 and/or to the device 124 in possession of a friend or a family member 106 of the home owner 118. In some configurations, the UE 102 may send the text to the device 116 in possession of the government authority 108 and/or to the device 124 in possession of a friend or a family member of the home owner 118 or a private security service 106 used by the home owner 118, separately from the recorded video.

In one configuration, the UE 102 may send a pointer to the saved information (e.g., recorded ambient sounds, the human voices, and the video) on the server 122 (e.g., a cloud server) to the device 116 in possession of the government authority 108 and/or to the device 124 in possession of a friend or a family member or a private security service 106 of the home owner 118, separately from the recorded video.

In one configuration, the UE 102 may turn on a GPS embedded in the UE 102. The UE 102 may transfer the current location of the UE 102 to the device 116 in possession of a government authority 108 (e.g. police operator) and/or to the device 124 in possession of a non-non-government security service authority 106 (e.g., a private security service) and/or a non-government authority 106 (e.g., a friend or a family member).

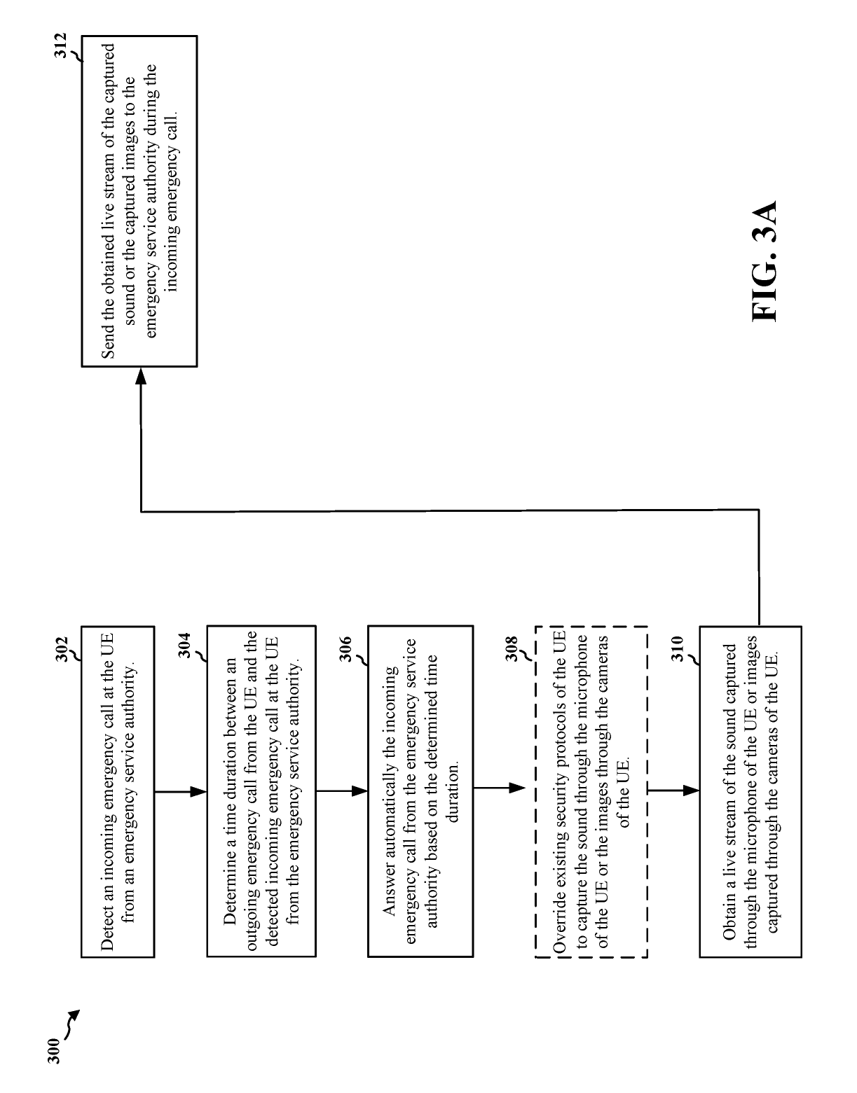

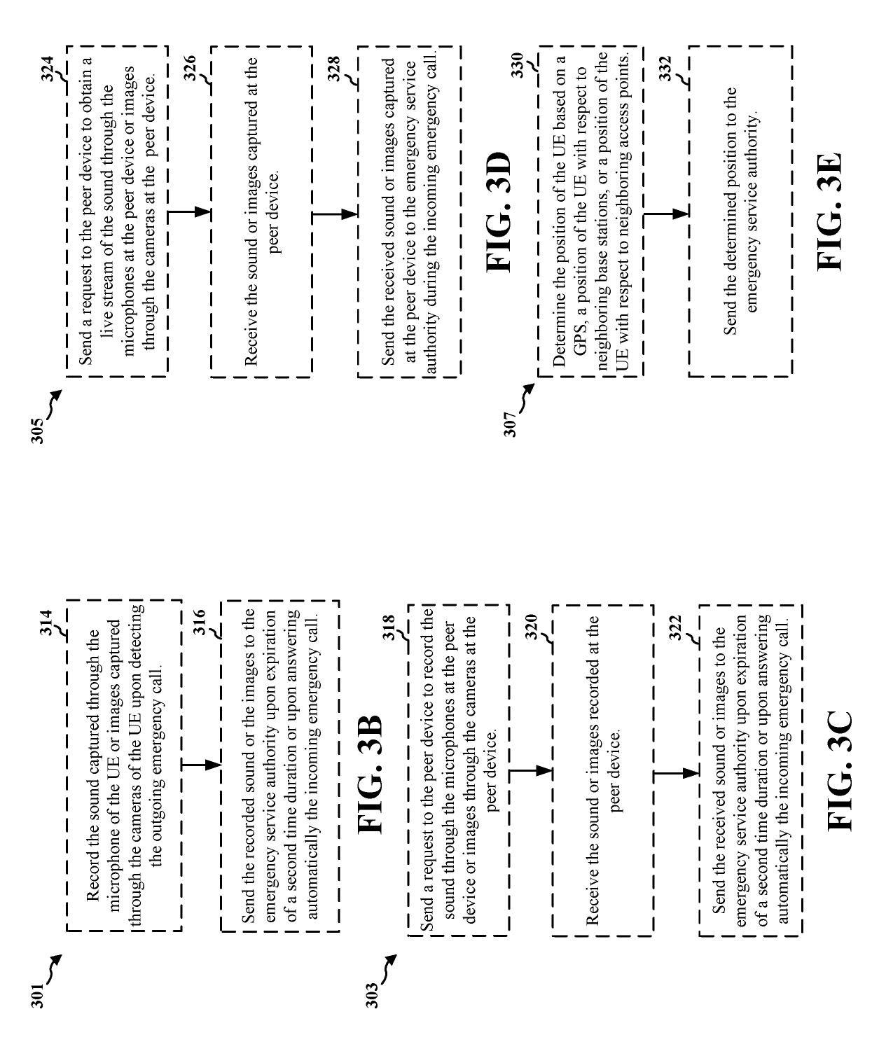

FIG. 3A is a flowchart 300 of a method of automatically answering an incoming emergency call at a UE, according to an aspect. The method may be performed by a UE (e.g., the UE 102).

At 302, the UE may detect an incoming emergency call at the UE from an emergency service authority. For example, the UE 102 may detect an incoming emergency call at the UE 102 from a police operator 108 or a private security service 106.

In one configuration, the UE 102 is one of a smart phone, a tablet, a laptop, an IoT device, an IoE device, an eMTC device, a CCTV camera, an electronic microphone. In another configuration, the emergency service authority may be a government emergency service authority (e.g., a police operator 108), a non-government emergency security service authority (e.g., a private security service 106), or a non-government authority (e.g., a friend or a family member). In some configurations, the government emergency service authority is a local police station or an emergency call center operated by the local police station (e.g., a police operator 108), the non-government emergency security service authority is a private security service provider (e.g., a private security service 106) of the owner of the UE, and the non-government authority is a friend or a family member of an owner of the UE.

At 304, the UE may determine a time duration between an outgoing emergency call from the UE and the detected incoming emergency call at the UE from the emergency service authority. For example, the UE 102 may determine a time duration between an outgoing emergency call from the UE 102 and the detected incoming emergency call at the UE 102 from a police operator 108 or a private security service 106. In one configuration, the UE 102 may detect that an emergency call is placed and start a timer. When an incoming emergency call is received, the UE 102 upon detecting that the incoming number is from an emergency service authority (e.g., a police operator 108 or a private security service 106), the UE 102 checks to see if the timer is running and if so stops the timer. If the timer was not running, then incoming call may not trigger any action. If the timer was running and the time duration is less than a threshold time duration (e.g., 5 minutes) then the UE 102 proceeds to 306.

At 306, the UE may answer automatically the incoming emergency call from the emergency service authority based on the determined time duration. For example, the UE 102 may answer automatically the incoming emergency call from a police operator 108 or a private security service 106 based on the determined time duration.

In one configuration, the incoming emergency call may be automatically answered when the determined time duration is less than a threshold time duration, and is not automatically answered when the determined time duration is greater than the threshold time duration. For example, the incoming emergency call may be automatically answered by the UE 102 when the determined time duration between the outgoing emergency call from the UE 102 and the detected incoming emergency call at the UE 102 from a police operator 108 or a private security service 106 is less 5 minutes. However, the incoming emergency call may not be automatically answered by the UE 102 when the determined time duration between the outgoing emergency call from the UE 102 and the detected incoming emergency call at the UE 102 from a police operator 108 or a private security service 106 is greater 5 minutes.

Optionally, at 308, the UE may override one or more existing security protocols embedded in an operating system of the UE in order to capture the at least one of the sound through the microphone of the UE or the images through the one or more cameras of the UE. For example, as soon as the incoming call from the emergency service authority (e.g. a police operator 108 or a private security service 106) is answered at the UE 102, the UE 102 may override the existing security protocols embedded in the operating system of the UE 102 in order to capture the at least one of the sound through the microphone of the UE 102 or the images through the one or more cameras of the UE 102. Overriding may be accomplished by invoking an API. Overriding may also be accomplished by invoking a mechanism inside the OS of the UE 102. In an aspect, the UE 102 may then turn on one or more microphones and/or sound recorders embedded in the UE 102 to capture and/or record ambient sounds (e.g., gunshots, one or more human voices, the conversation between the caller/the home owner 118 and the perpetrator 120). The UE (UE 102) may also turn on one or more cameras embedded in the UE 102 to capture and/or record the ambient environment (e.g., video of the burglary in action at the home owner's 118 house) of the UE 102.

At 310, the UE may obtain a live stream of at least one of sound captured through a microphone of the UE or images captured through one or more cameras of the UE upon answering the incoming emergency call. For example, the UE 102 may obtain a live stream of at least one of sound (e.g., gunshots, the human voices, the conversation between the caller/home owner 118 and the perpetrator 120) captured through a microphone of the UE 102 or images (e.g., still/video of the burglary in action at the location of the caller/the home owner's 118 house) captured through one or more cameras of the UE 102 upon answering the incoming emergency call.

At 312, the UE may send the obtained live stream of the at least one of the captured sound or the captured images to the emergency service authority during the incoming emergency call. For example, the UE 102 may send the obtained live stream of the at least one of the captured sound (e.g., gunshots, the human voices, the conversation between the caller/the home owner 118 and the perpetrator 120) or the captured images (e.g., still/video of the burglary in action at the location of the caller/the home owner's 118 house) to the police operator 108 or a private security service or a friend or a family member 106 during the incoming emergency call.

FIG. 3B is a flowchart 301 of a method of recording and sending the sound or images captured by the UE to the emergency service authority, according to an aspect. The method may be performed by a UE (e.g., the UE 102). Different blocks of the method of FIG. 3B may be optionally performed after block 308 of the method 300 of FIG. 3A.

Optionally, at 314, the UE may record at least one of sound captured through the microphone of the UE or images captured through the one or more cameras of the UE upon detecting the outgoing emergency call. For example, the UE 102 may record at least one of sound (e.g., gunshots, the human voices, the conversation between the caller/the home owner 118 and the perpetrator 120) captured through the microphone of the UE 102 or images (e.g., video of the burglary in action at the caller's location/the home owner's 118 house) captured through the one or more cameras of the UE 102 upon detecting the outgoing emergency call.

Optionally, at 316, the UE may send the recorded at least one of the captured sound or the captured images to the emergency service authority upon expiration of a second time duration or upon answering automatically the incoming emergency call. For example, the UE 102 may send the recorded at least one of the captured sound captured sound (e.g., gunshots, the human voices, the conversation between the caller/the home owner 118 and the perpetrator 120) or the captured images (e.g., still/video of the burglary in action at the location of the caller/the home owner's 118 house) to the police operator 108 or a private security service or a friend or a family member 106 upon expiration of a second time duration (e.g., 10 minutes from the outgoing emergency call) or upon answering automatically the incoming emergency call.

FIG. 3C is a flowchart 303 of a method of recording sound or images at the peer device and sending the recorded sound or images to the emergency service authority, according to an aspect. The method may be performed by a UE (e.g., the UE 102). Different blocks of the method of FIG. 3C may be performed after 302 of the method 300 of FIG. 3A.

Optionally, at 318, upon detecting an outgoing emergency call from the UE, the UE may send a request to at least one peer device in a vicinity of the UE to record at least one of sound through one or more microphones at the at least one peer device or images through one or more cameras at the at least one peer device. For example, upon detecting an outgoing emergency call from the UE 102, the UE 102 may send a request to at least one peer device (e.g., 110, 112, 114) in a vicinity of the UE 102 to record at least one of sound (e.g., gunshots, the human voices, the conversation between the caller/home owner 118 and the perpetrator 120) through one or more microphones at the at least one peer device (e.g., 110, 112, 114) or images (e.g., still/video of the burglary in action at the location of the caller/the home owner's 118 house) through one or more cameras at the at least one peer device (e.g., 110, 112, 114).

In one configuration, UE 102 may send to the peer device (e.g., 110, 112, 114) a request to allow the UE 102 to override the exiting security protocols embedded in the operating system of the peer device (e.g., 110, 112, 114). Once the peer device (e.g., 110, 112, 114) accepts the UE's 102 request, the UE 102 may override the security protocols embedded in the operating system of the peer device (e.g., 110, 112, 114) and may take full control of the peer device (e.g., 110, 112, 114). In one configuration, the overriding may be accomplished by invoking an API. In another configuration, a preconfigured code may be sent from the UE 102 to the peer device (e.g., 110, 112, 114) to allow the security protocols of the peer device (e.g., 110, 112, 114) to be overridden. In an aspect, the overriding may also be accomplished by invoking a mechanism inside the OS of the peer device (e.g., 110, 112, 114). Once the security protocols of the peer device (e.g., 110, 112, 114) are overridden by the UE 102, the UE 102 may turn on one or more microphones and/or sound recorders embedded in the peer device (e.g., 110, 112, 114) to capture and/or record ambient sounds (e.g., sound of a gunshot, human voices, conversation between the caller/the home owner 118 and the perpetrator 120). UE 102 may also turn on one or more cameras embedded in the peer device (e.g., 110, 112, 114) to capture and/or record the ambient environment of the peer device (e.g., 110, 112, 114). For example, in case of a home invasion burglary, the cameras in the laptop computer 114 may record the video of the burglary in action from different angles than the camera in the UE 102, which may help in identifying the perpetrator 120.

Optionally, at 320, the UE may receive at least one of the sound or images recorded at the at least one peer device. For example, the UE 102 may receive at least one of the sound (e.g., gunshots, the human voices, the conversation between the caller/the home owner 118 and the perpetrator 120) or images (e.g., still/video of the burglary in action at the location of the caller/the home owner's 118 house) recorded at the at least one peer device (e.g., 110, 112, 114).

Optionally, at 322, the UE may send the at least one of the received sound or images recorded at the at least one peer device to the emergency service authority upon expiration of a second time duration or upon answering automatically the incoming emergency call. For example, the UE 102 may send the at least one of the received sound (e.g., gunshots, the human voices, the conversation between the caller/the home owner 118 and the perpetrator 120) or images (e.g., still/video of the burglary in action at the location of the caller/the home owner's 118 house) recorded at the at least one peer device (e.g., 110, 112, 114) to the police operator 108 or a private security service or a friend or a family member 106 upon expiration of a second time duration (e.g., 10 minutes from the outgoing emergency call) or upon answering automatically the incoming emergency call.

FIG. 3D is a flowchart 305 of a method of obtaining a live stream of sound or images through the peer device and sending the live stream to the emergency service authority, according to an aspect. The method may be performed by a UE (e.g., the UE 102). Different blocks of the method of FIG. 3D may be performed after block 306 of the method 300 of FIG. 3A.

Optionally, at 324, the UE may send, upon answering automatically the incoming emergency call, a request to at least one peer device in a vicinity of the UE to obtain a live stream of at least one of sound through one or more microphones at the at least one peer device or images through one or more cameras at the at least one peer device. For example, the UE 102 may send, upon answering automatically the incoming emergency call at the UE 102, a request to at least one peer device (e.g., 110, 112, 114) in a vicinity of the UE 102 to obtain a live stream of at least one of sound (e.g., gunshots, the human voices, the conversation between the caller/the home owner 118 and the perpetrator 120) through one or more microphones at the at least one peer device (e.g., 110, 112, 114) or images (e.g., still/video of the burglary in action at the location of the caller/the home owner's 118 house) through one or more cameras at the at least one peer device (e.g., 110, 112, 114).

Optionally, at 326, the UE may receive at least one of the sound or images captured at the at least one peer device. For example, the UE 102 may receive at least one of the sound (e.g., gunshots, the human voices, the conversation between the caller/the home owner 118 and the perpetrator 120) or images (e.g., still/video of the burglary in action at the location of the caller/the home owner's 118 house) captured at the at least one peer device (e.g., 110, 112, 114).

Optionally, at 328, the UE may send the at least one of the received sound or images captured at the at least one peer device to the emergency service authority during the incoming emergency call. For example, the UE 102 may send the at least one of the received sound (e.g., gunshots, the human voices, the conversation between the caller/the home owner 118 and the perpetrator 120) or images (e.g., still/video of the burglary in action at the location of the caller/the home owner's 118 house) captured at the at least one peer device (e.g., 110, 112, 114) to the police operator 108 or a private security service or a friend or a family member 106, during the incoming emergency call.

FIG. 3E is a flowchart 307 of a method of determining the position of the UE and sending the determined position to the emergency service authority, according to an aspect. The method may be performed by a UE (e.g., the UE 102). Different blocks of the method of FIG. 3E may be performed after block 302 of the method 300 of FIG. 3A.

Optionally, at 330, the UE may determine, upon detecting the outgoing emergency call, at least one position of the UE based on at least one of a GPS, a position of the UE with respect to neighboring base stations, or a position of the UE with respect to neighboring access points. For example, the UE 102 may determine, upon detecting the outgoing emergency call from the UE 102, at least one position of the UE 102 based on at least one of a GPS at the UE 102, a position of the UE 102 with respect to neighboring base stations, or a position of the UE 102 with respect to neighboring access points.

Optionally, at 332, the UE may send the determined at least one position to the emergency service authority. For example, the UE 102 may send the determined at least one position of the UE 102 to the police operator 108 or a private security service or a friend or a family member 106.

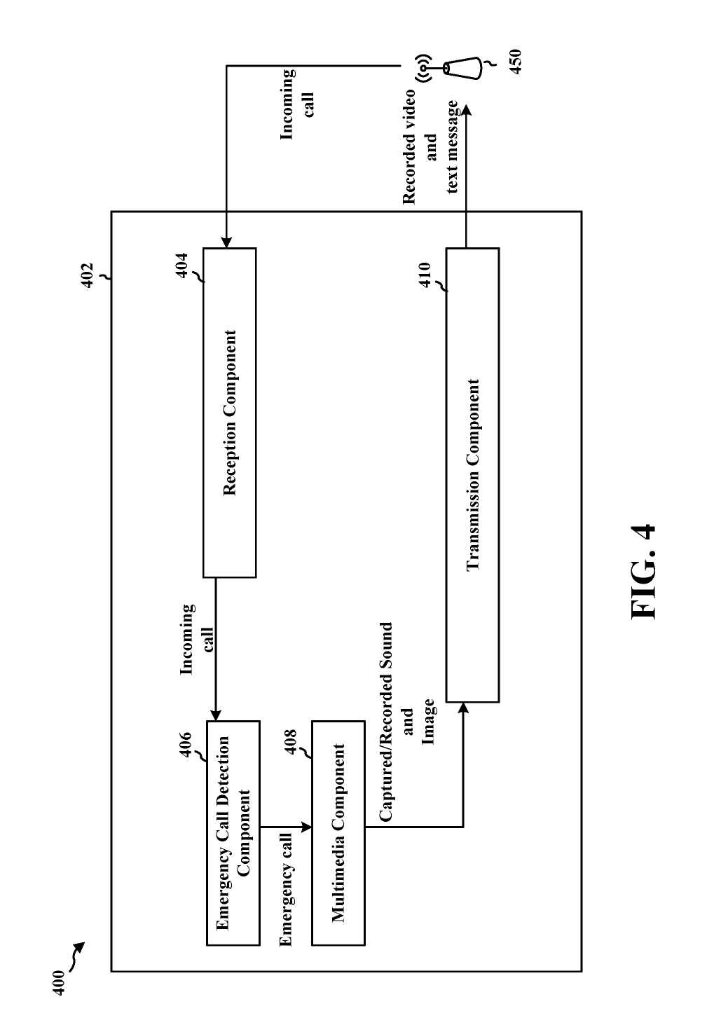

FIG. 4 is a conceptual data flow diagram 400 illustrating the data flow between different means/components in an exemplary apparatus 402 for emergency call detection. The apparatus may be a UE including a SIM, at least one processor and a memory coupled to the at least one processor or a modem including a MME memory, at least one processor fragment.

In an aspect, the apparatus 402 may include a reception component 404 that receives an emergency call from an authority (e.g. a police operator 108 or a private security service 106) via a base station 450. The apparatus 402 also includes an emergency call detection component 406 that detects an incoming emergency call from the emergency service authority (e.g. a police operator 108 or a private security service 106). The emergency call detection component 406 also detects an outgoing emergency call originated from the apparatus 402, by recognizing the emergency phone number. The emergency call detection component 406 may also determine a time duration between an outgoing emergency call originated from the apparatus 402 and an incoming emergency call from the emergency service authority (e.g. a police operator 108 or a private security service 106). Additionally, the emergency call detection component 406 may enable an auto answer feature to automatically answer the incoming emergency call from the emergency service authority (e.g. a police operator 108 or a private security service 106), based on the determined time duration between the outgoing emergency call originated from the apparatus 402 and the incoming emergency call from the emergency service authority (e.g. a police operator 108 or a private security service 106).

The apparatus 402 may also include a multimedia component 408 to capture and/or record audio of the ambient sounds, human voices, and the image (e.g., still and/or video) of the ambient environment of the apparatus 402. The multimedia component 408 may convert, as an attachment, the recorded human voices to text format. The apparatus 402 further includes a transmission component 410 to transfer the captured and/or recorded video and the text to at least one device (e.g., 116, 124) in possession of the emergency service authority (e.g. a police operator 108 or a private security service or a friend or a family member 106) via the base station 450. The transmission component 410 may also transfer a live feed of the ambient sounds, human voices and the video of the ambient environment of the apparatus 402 to at least one device (e.g., 116, 124) in possession of the emergency service authority (e.g. a police operator 108 or a private security service a friend a family member 106) via the base station 450.

The apparatus 402 may include additional components that perform each of the blocks of the algorithm in the aforementioned flowchart 200 of FIG. 2 or flowchart 300 of FIG. 3A flowchart 301 of FIG. 3B, flowchart 303 of FIG. 3C, flowchart 305 of FIG. 3D, or flowchart 307 of FIG. 3E. As such, each block in the aforementioned flowcharts of FIG. 2/FIG. 3A/FIG. 3B/FIG. 3C/FIG. 3D/FIG. 3E may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

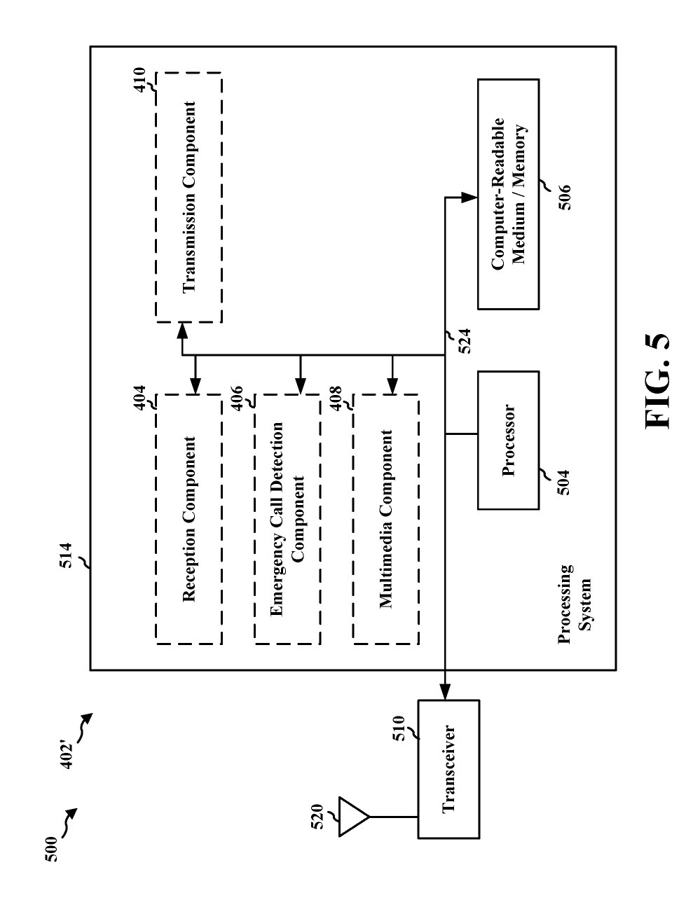

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware components, represented by the processor 504, the reception component 404, the emergency call detection component 406, the multimedia component 408, the transmission component 410, and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the reception component 404. In addition, the transceiver 510 receives information from the processing system 514, specifically the transmission component 410, and based on the received information, generates a signal to be applied to the one or more antennas 520.

The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system 514 further includes at least one of the reception component 404, the emergency call detection component 406, the multimedia component 408, and the transmission component 410. The components may be software components running in the processor 504, resident/stored in the computer readable medium/memory 506, one or more hardware components coupled to the processor 504, or some combination thereof.

In one configuration, the apparatus 402/402′ for emergency call detection includes means for detecting an incoming emergency call at a UE from an emergency service authority. The apparatus 402/402′ for emergency call detection further includes means for determining a time duration between an outgoing emergency call from the UE and the detected incoming emergency call at the UE from the emergency service authority. The apparatus 402/402′ for emergency call detection also includes means for answering automatically the incoming emergency call from the emergency service authority based on the determined time duration. Additionally, the apparatus 402/402′ for emergency call detection includes means for obtaining a live stream of at least one of sound captured through a microphone of the UE or images captured through one or more cameras of the UE upon answering the incoming emergency call, and means for sending the obtained live stream of the at least one of the captured sound or the captured images to the emergency service authority during the incoming emergency call.

In a configuration, the incoming emergency call is automatically answered when the determined time duration is less than a threshold time duration, and is not automatically answered when the determined time duration is greater than the threshold time duration. In another configuration, the apparatus 502/502′ for emergency call detection further includes means for overriding one or more existing security protocols embedded in an operating system of the UE in order to capture the at least one of the sound through the microphone of the UE or the images through the one or more cameras of the UE.

In some configurations, the emergency service authority is at least one of a government emergency service authority, a non-government emergency security service authority, or a non-government authority, wherein the government emergency service authority is a local police station or an emergency call center operated by the local police station, the non-government emergency security service authority is a private security service provider of the owner of the UE, and the non-government authority is a friend or a family member of an owner of the UE.

In one configuration, the apparatus 402/402′ for emergency call detection also includes means for recording at least one of sound captured through the microphone of the UE or images captured through the one or more cameras of the UE upon detecting the outgoing emergency call, and the means for sending is further configured to send the recorded at least one of the captured sound or the captured images to the emergency service authority upon expiration of a second time duration or upon answering automatically the incoming emergency call. In an aspect, the means for sending is further configured to send, upon detecting the outgoing emergency call, a request to at least one peer device in a vicinity of the UE to record at least one of sound through one or more microphones at the at least one peer device or images through one or more cameras at the at least one peer device.

In some configurations, the apparatus 402/402′ for emergency call detection further includes means for receiving at least one of the sound or images recorded at the at least one peer device. In an aspect, the means for sending is further configured to send the at least one of the received sound or images recorded at the at least one peer device to the emergency service authority upon expiration of a second time duration or upon answering automatically the incoming emergency call. In another aspect, the means for sending is further configured to send, upon answering automatically the incoming emergency call, a request to at least one peer device in a vicinity of the UE to obtain a live stream of at least one of sound through one or more microphones at the at least one peer device or images through one or more cameras at the at least one peer device.

In one configuration, the apparatus 402/402′ for emergency call detection also includes means for receiving at least one of the sound or images captured at the at least one peer device. In an aspect, the means for sending is further configured to send the at least one of the received sound or images captured at the at least one peer device to the emergency service authority during the incoming emergency call. In another aspect, the UE is one of a smart phone, a tablet, a laptop, an IoT device, an IoE device, an eMTC device, a CCTV camera, an electronic microphone.

In some configurations, the means for determining is further configured to determine, upon detecting the outgoing emergency call, at least one position of the UE based on at least one of a GPS, a position of the UE with respect to neighboring base stations, or a position of the UE with respect to neighboring access points. In some other configuration, the means for sending is further configured to send the determined at least one position to the emergency service authority.

The aforementioned means may be one or more of the aforementioned components of the apparatus 402/402′ for emergency call detection and/or the processing system 514 of the apparatus 402/402″ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of emergency call detection at a user equipment (UE), comprising:
detecting an incoming emergency call at the UE from an emergency service authority;
determining a time duration between an outgoing emergency call from the UE and the detected incoming emergency call at the UE from the emergency service authority;
answering automatically the incoming emergency call from the emergency service authority based on the determined time duration;
obtaining a live stream of sound captured through a microphone of the UE and images captured through one or more cameras of the UE upon answering the incoming emergency call; and
sending the obtained live stream of the captured sound and the captured images to the emergency service authority during the incoming emergency call,
wherein the incoming emergency call is automatically answered when the determined time duration is less than a threshold time duration, and is not automatically answered when the determined time duration is greater than the threshold time duration.

2. (canceled)

3. The method of claim 1, further comprising overriding one or more existing security protocols embedded in an operating system of the UE in order to capture the sound through the microphone of the UE and the images through the one or more cameras of the UE.

4. The method of claim 1, wherein the emergency service authority is at least one of a government emergency service authority, a non-government emergency security service authority, or a non-government authority, wherein the government emergency service authority is a local police station or an emergency call center operated by the local police station, the non-government emergency security service authority is a private security service provider of an owner of the UE, and the non-government authority is a friend or a family member of the owner of the UE.

5. The method of claim 1, further comprising:
recording at least one of the sound captured through the microphone of the UE or the images captured through the one or more cameras of the UE upon detecting the outgoing emergency call; and
sending the recorded at least one of the captured sound or the captured images to the emergency service authority upon expiration of a second time duration or upon answering automatically the incoming emergency call.

6. The method of claim 1, further comprising sending, upon detecting the outgoing emergency call, a request to at least one peer device in a vicinity of the UE to record at least one of sound through one or more microphones at the at least one peer device or images through one or more cameras at the at least one peer device.

7. The method of claim 6, further comprising:
receiving at least one of the sound or the images recorded at the at least one peer device; and
sending the at least one of the received sound or images recorded at the at least one peer device to the emergency service authority upon expiration of a second time duration or upon answering automatically the incoming emergency call.

8. The method of claim 1, further comprising sending, upon answering automatically the incoming emergency call, a request to at least one peer device in a vicinity of the UE to obtain a live stream of at least one of sound through one or more microphones at the at least one peer device or images through one or more cameras at the at least one peer device.

9. The method of claim 8, further comprising
receiving at least one of the sound or the images captured at the at least one peer device; and
sending the at least one of the received sound or images captured at the at least one peer device to the emergency service authority during the incoming emergency call.

10. The method of claim 1, wherein the UE is one of a smart phone, a tablet, a laptop, an Internet of Things (IoT) device, an Internet of Everything (IoE) device, an enhanced Machine Type Communications (eMTC) device, a closed-circuit television (CCTV) camera, an electronic microphone.

11. The method of claim 1, further comprising:
determining, upon detecting the outgoing emergency call, at least one position of the UE based on at least one of a global positioning system (GPS), a position of the UE with respect to neighboring base stations, or a position of the UE with respect to neighboring access points; and
sending the determined at least one position to the emergency service authority.

12. An apparatus for emergency call detection, comprising:
means for detecting an incoming emergency call at a user equipment (UE) from an emergency service authority;
means for determining a time duration between an outgoing emergency call from the UE and the detected incoming emergency call at the UE from the emergency service authority;
means for answering automatically the incoming emergency call from the emergency service authority based on the determined time duration;
means for obtaining a live stream of sound captured through a microphone of the UE and images captured through one or more cameras of the UE upon answering the incoming emergency call; and
means for sending the obtained live stream of the captured sound and the captured images to the emergency service authority during the incoming emergency call, wherein the incoming emergency call is automatically answered when the determined time duration is less than a threshold time duration, and is not automatically answered when the determined time duration is greater than the threshold time duration.

13. (canceled)

14. The apparatus of claim 12, further comprising means for overriding one or more existing security protocols embedded in an operating system of the UE in order to capture the sound through the microphone of the UE and the images through the one or more cameras of the UE.

15. The apparatus of claim 12, wherein the emergency service authority is at least one of a government emergency service authority, a non-government emergency security service authority, or a non-government authority, wherein the government emergency service authority is a local police station or an emergency call center operated by the local police station, the non-government emergency security service authority is a private security service provider of an owner of the UE, and the non-government authority is a friend or a family member of the owner of the UE.

16. The apparatus of claim 12, further comprising:
means for recording at least one of the sound captured through the microphone of the UE or the images captured through the one or more cameras of the UE upon detecting the outgoing emergency call; and
the means for sending is further configured to send the recorded at least one of the captured sound or the captured images to the emergency service authority upon expiration of a second time duration or upon answering automatically the incoming emergency call.

17. The apparatus of claim 12, wherein the means for sending is further configured to send, upon detecting the outgoing emergency call, a request to at least one peer device in a vicinity of the UE to record at least one of sound through one or more microphones at the at least one peer device or images through one or more cameras at the at least one peer device.

18. The apparatus of claim 17, further comprising
means for receiving at least one of the sound or the images recorded at the at least one peer device; and
the means for sending is further configured to send the at least one of the received sound or images recorded at the at least one peer device to the emergency service authority upon expiration of a second time duration or upon answering automatically the incoming emergency call.

19. The apparatus of claim 12, wherein the means for sending is further configured to send, upon answering automatically the incoming emergency call, a request to at least one peer device in a vicinity of the UE to obtain a live stream of at least one of sound through one or more microphones at the at least one peer device or images through one or more cameras at the at least one peer device.

20. The apparatus of claim 19, further comprising
means for receiving at least one of the sound or the images captured at the at least one peer device; and
the means for sending is further configured to send the at least one of the received sound or images captured at the at least one peer device to the emergency service authority during the incoming emergency call.

21. The apparatus of claim 12, wherein the UE is one of a smart phone, a tablet, a laptop, an Internet of Things (IoT) device, an Internet of Everything (IoE) device, an enhanced Machine Type Communications (eMTC) device, a closed-circuit television (CCTV) camera, an electronic microphone.

22. The apparatus of claim 12, wherein
the means for determining is further configured to determine, upon detecting the outgoing emergency call, at least one position of the UE based on at least one of a global positioning system (GPS), a position of the UE with respect to neighboring base stations, or a position of the UE with respect to neighboring access points; and
the means for sending is further configured to send the determined at least one position to the emergency service authority.

23. An apparatus for emergency call detection, comprising:
a memory; and
at least one processor coupled to the memory and configured to:
detect an incoming emergency call at a user equipment (UE) from an emergency service authority;
determine a time duration between an outgoing emergency call from the UE and the detected incoming emergency call at the UE from the emergency service authority;
answer automatically the incoming emergency call from the emergency service authority based on the determined time duration;
obtain a live stream of sound captured through a microphone of the UE and images captured through one or more cameras of the UE upon answering the incoming emergency call; and
send the obtained live stream of the captured sound and the captured images to the emergency service authority during the incoming emergency call, wherein the incoming emergency call is automatically answered when the determined time duration is less than a threshold time duration, and is not automatically answered when the determined time duration is greater than the threshold time duration.

24. (canceled)

25. The apparatus of claim 23, wherein the at least one processor is further configured to override one or more existing security protocols embedded in an operating system of the UE in order to capture the sound through the microphone of the UE and the images through the one or more cameras of the UE.

26. The apparatus of claim 23, wherein the emergency service authority is at least one of a government emergency service authority, a non-government emergency security service authority, or a non-government authority, wherein the government emergency service authority is a local police station or an emergency call center operated by the local police station, the non-government emergency security service authority is a private security service provider of an owner of the UE, and the non-government authority is a friend or a family member of the owner of the UE.

27. The apparatus of claim 23, wherein the at least one processor is further configured to:
record at least one of the sound captured through the microphone of the UE or the images captured through the one or more cameras of the UE upon detecting the outgoing emergency call; and
send the recorded at least one of the captured sound or the captured images to the emergency service authority upon expiration of a second time duration or upon answering automatically the incoming emergency call.

28. The apparatus of claim 23, wherein the at least one processor is further configured to send, upon detecting the outgoing emergency call, a request to at least one peer device in a vicinity of the UE to record at least one of sound through one or more microphones at the at least one peer device or images through one or more cameras at the at least one peer device.

29. The apparatus of claim 28, wherein the at least one processor is further configured to:
receive at least one of the sound or the images recorded at the at least one peer device; and
send the at least one of the received sound or images recorded at the at least one peer device to the emergency service authority upon expiration of a second time duration or upon answering automatically the incoming emergency call.

30. A non-transitory computer-readable medium storing computer executable code, comprising code to:
detect an incoming emergency call at a user equipment (UE) from an emergency service authority;
determine a time duration between an outgoing emergency call from the UE and the detected incoming emergency call at the UE from the emergency service authority;
answer automatically the incoming emergency call from the emergency service authority based on the determined time duration;
obtain a live stream of sound captured through a microphone of the UE and images captured through one or more cameras of the UE upon answering the incoming emergency call; and
send the obtained live stream of the captured sound and the captured images to the emergency service authority during the incoming emergency call wherein the incoming emergency call is automatically answered when the determined time duration is less than a threshold time duration, and is not automatically answered when the determined time duration is greater than the threshold time duration.
